(19) United States
(12) Patent Application Publication
(10) Pub. No.: US 2019/0030562 A1
(43) Pub. Date: Jan. 31, 2019

(54) IMPROVED COATING PROCESS AND APPARATUS

(71) Applicant: BENEQ OY, Espoo (FI)

(72) Inventors: Kai ASIKKALA, Espoo (FI); Simo TAMMELA, Espoo (FI); Tuomo MÄÄTTÄ, Espoo (FI)

(21) Appl. No.: 16/072,163

(22) PCT Filed: Feb. 23, 2017
(86) PCT No.: PCT/FI2017/050118

§ 371 Date: Jul. 23, 2018

(30) Foreign Application Priority Data
Feb. 26, 2016 (FI) 20165150

(51) Int. Cl. B05D 1/36; B05D 1/12; B05D 7/00; B05B 7/14; B05B 13/02

(52) U.S. Cl. CPC B05D 1/36; B05D 1/12; B05B 13/02; B05B 7/14; B05D 7/54

(57) ABSTRACT

A multi-component coating apparatus that includes at least two deposition chambers. Aerosol in the chambers is adjusted to a to a non-impact state in which particles of the aerosol settle onto surfaces exposed to the aerosol a limited interaction period. The surface to be coated is transferred from the first chambers to the second chamber in a predefined period during which chemical interaction between the first substance and the second substance is enabled. The arrangement is very simple and robust, so also larger scale objects, for example in the order of vehicle or machinery components may be coated with very thin films.

### BACKGROUND

The invention relates to a coating device and a coating method as defined in the preambles of the independent claims.

### DESCRIPTION OF THE RELATED ART

In prior art coating systems, an aerosol jet is directed toward a substrate such that droplets of the aerosol jet impact the surface of the substrate to be coated. Typically the atomizing head is arranged to face the surface to be coated so that the aerosol jet points to an impact point on a surface of the substrate. The aerosol travels on the surface of the substrate to another point where parts of the aerosol that has not participated in the coating process is removed.

In some other prior art solutions, two atomized aerosol jets are oriented opposite each other so that aerosol is produced to the collision point of the aerosol jets. The produced aerosol is moved toward the substrate to be coated by means of a gas stream blown to the collision point.

It has proven difficult to use these prior art impaction-based coating mechanisms to create thin, uniform multi-component coating films of two or more components. Multi-component process is used in this context to mean that the process for forming a coating resulting from the process requires a chemical interaction between two different substances. Conventionally, films have been created in multi-component processes by spraying successively separate substances on top of each other, or by mixing substances required in the multi-component process to each other before spraying them onto the coated surface.

In either of these methods, coating of complex objects with hollows or curvy forms is problematic. For a uniform coating, each of the coated surfaces should be evenly exposed to the impacting spray. This means that the coating device must include a mechanism that changes the orientation of the coated object in relation of the impacting spray according to its shape. Implementation of such orientation changing mechanisms, especially for larger scale objects, is complicated and very expensive. Furthermore, even with such moving mechanisms, production of thin, even films is challenging. In order to ensure that all surface parts do get exposed, despite the potentially intervening forms between the spray and the current part to be sprayed, many parts may be exposed to the spray several times or longer periods or both. Therefore, the thickness of the film on the coated surfaces tends to vary considerably.

Even in coating of planar objects, the conventional methods have challenges. Impaction methods are inherently prone to variations in thickness of the coating. Furthermore, production of a multi-layer film includes two separate spraying processes, whereby the resulting coating tends to be even more prone to accumulated variations. On the other hand, substances that are sprayed as a mix do not always mix perfectly, and tend to result in non-uniform composition of the coating.

Atomic layer deposition (ALD) method is based on use of a gas phase chemical process, in which precursors react with the surface of a material one at a time in a sequential, self-limiting manner. Through the repeated reactions, a coating film is created. The resulting film is very uniform even on complex surfaces, but the process is slow and does not easily scale to coating of large objects.

### SUMMARY

An object of the present invention is to provide a system that enables creation of even and thin coating films in a multi-component process.

Embodiments of a coating method are characterized by the definitions of the independent claim 1. Some embodiments of the coating method are defined in the dependent claims 2 to 14.

Embodiments of a coating apparatus are correspondingly characterized by the definitions of independent claim 15. Some embodiments of the coating apparatus are defined in the dependent claims 16 to 26.

Embodiments of a coated object are correspondingly characterized by the definitions of independent claim 27. Some embodiments of the coating apparatus are defined in the dependent claims 28 and 29

An embodiment of the coating method describes depositing a coating in a process that includes chemical interaction between a first substance and a second substance; creating into a first chamber an aerosol that includes particles of the first substance; creating into a second chamber an aerosol that includes particles of the second substance; determining a limited interaction period during which the chemical interaction between the first substance and the second substance is enabled, the limited interaction period being initiated in the beginning or end of exposure of the surface of the object to the aerosol in the first chamber; adjusting the aerosol in the first chamber or in the second chamber to a non-impact state in which particles of the aerosol settle onto surfaces exposed to the aerosol; loading the surface of the object into the first chamber; and loading the surface of the object into the second chamber before termination of the limited interaction period

Another embodiment discloses an apparatus for a process that that includes chemical interaction between a first substance and a second substance. The apparatus includes a first chamber; a second chamber; a first aerosol source for feeding into the first chamber an aerosol that includes particles of the first substance; a second aerosol source for feeding into the second chamber an aerosol that includes particles of the second substance; a second aerosol source for feeding into the second chamber an aerosol that includes particles of the second substance, wherein the first aerosol source or the second aerosol source is configured to adjust the aerosol to a non-impact state in which particles of the aerosol settle onto surfaces exposed to the aerosol; a loading element configured to load at least one surface of an object into the first chamber, and before termination of a limited interaction period into the second chamber, wherein the chemical interaction is enabled only during the limited interaction period, which is initiated in the beginning or end of exposure of the surface of the object to the aerosol in the first chamber.

Another embodiment discloses a coated object, at least one surface of the object having a coating deposited by the above described coating method.

The use of the specific non-impact deposition mechanism ensures that the coating process does not require complex control mechanisms for spray impaction angles, and is therefore also applicable to create very even coatings even on large scale objects. The thickness of the uniform film can be controlled in a very simple manner by adjusting the time of exposure to the non-impacting aerosol. This also enables easy control for the multi-component coating process, especially control of the multi-component composition of the resulting firm, or of forming the resulting single-component film.

Further embodiments and advantages of the invention are discussed in more detail with the following disclosure

### BRIEF DESCRIPTION OF THE DRAWINGS

In the following the invention will described in more detail by referring to the attached drawings, in which:

FIG. 1 illustrates an exemplary embodiment of a coating apparatus with two successive deposition chambers;

FIG. 2 illustrates the relationship between the limited interaction period and the first interaction period;

FIG. 3 illustrates a coating device including an exemplary deposition chamber;

FIG. 4 illustrates a coating device including another exemplary deposition chamber;

FIG. 5 illustrates a coating device that includes two successive deposition chambers;

FIG. 6 illustrates a coating device that includes three successive deposition chambers;

FIG. 7 illustrates an example of direct coupling of the deposition chambers;

FIG. 8 illustrates directly coupled deposition chambers with one intermediate chamber;

FIG. 9 illustrates directly coupled deposition chambers with three intermediate chambers.

### DETAILED DESCRIPTION

The following embodiments are exemplary. Although the specification may refer to “an”, “one”, or “some” embodiment(s), this does not necessarily mean that each such reference is to the same embodiment(s), or that the feature only applies to a single embodiment. Single features of different embodiments may be combined to provide further embodiments.

In the following, features of the invention will be described with a simple example of a device architecture with which various embodiments of the invention may be implemented. Only elements relevant for illustrating the embodiments are described in detail. Various aspects of coating methods and apparatuses, which are generally known to a person skilled in the art, may not be specifically described herein.

A multi-component coating process described herein includes chemical interaction between a first substance and a second substance. Multi-component coating process may be implemented by loading an object successively into the two or more coating cells, a first chamber and a second chamber. An aerosol that includes particles of the first substance is created into the first chamber, and an aerosol that includes particles of the second substance is created into the second chamber.

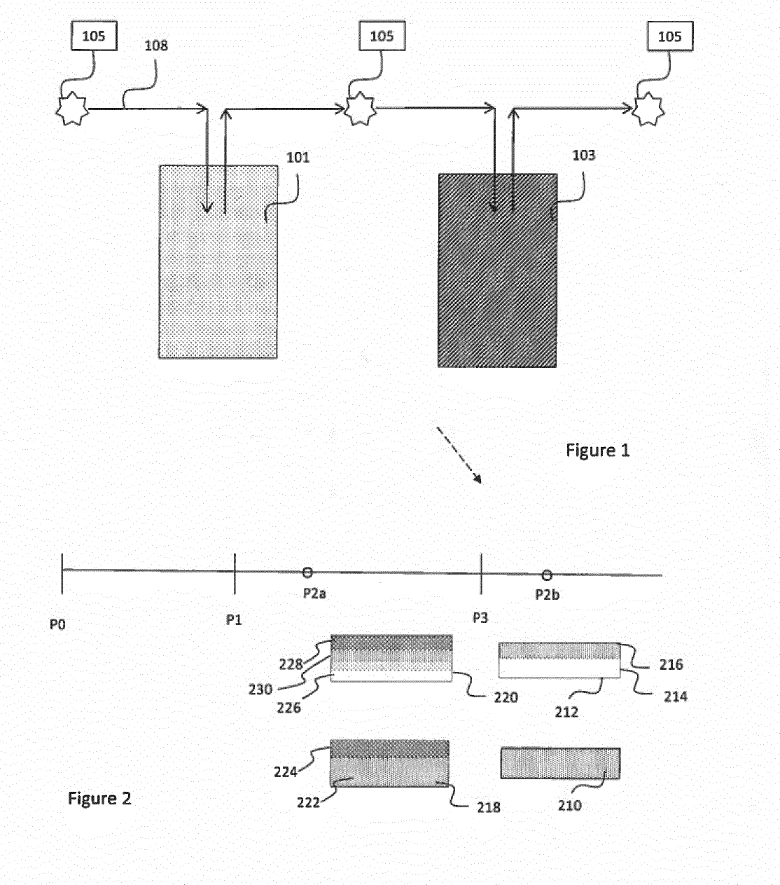

The schematic drawing FIG. 1 illustrates an exemplary embodiment of a coating apparatus that includes two successive deposition chambers 101, 103. FIG. 1 shows one object 105 in various stages of its progress of being loaded successively into the two deposition chambers. For the desired coating, the aerosol in at least one of the first chamber 101 and in the second chamber 103 is adjusted to a non-impact state in which particles of the aerosol settle onto surfaces exposed to the aerosol. The non-impact state is achieved by adjusting parameters of the aerosol creation, like size of the particles, temperature, air flow, and the like. The term settle thus refers here to a process where particles of an aerosol come into contact with a surface of a solid object without an induced flow, i.e. settle by gravitation or as a result of inter-particle interactions in the vicinity of the object. The first substance and the second substance may be of different composition to achieve a desired effect in the coating process, or in the properties of the resulting coating. For example, a defined coating type, improved adhesion of the coating to the coated surface, or a decrease to the process duration may be achieved.

It is noted that the surface of the object may have various different sub-forms divided from each other by, for example, edges, recesses, or the like. The use of aerosols in non-impact state is well suited for coating evenly various sub-forms or sub-surfaces of objects, but the process is also applicable for coating only selected sub-forms. For example, the object may be a large planar object, coating is made on one side and deposition in the backside is disabled by a detachably adhesive cover. In the following a term target surface is applied to refer to a surface to be coated. The target surface may comprise the whole surface of the object, or only a sub-surface of the object, which sub-surface is to be coated in the process.

The chemical interaction between the first substance and the second substance is enabled for a limited interaction period that is initiated in the beginning or end of exposure of the target surface of the object to the aerosol in the first chamber. For example, the limited interaction period may start at beginning of exposure of the target surface to the aerosol in the first chamber, i.e. when an object is loaded into the first chamber. On the other hand, the limited interaction period may start at a time the target surface is unloaded from the first deposition chamber. The length of the limited interaction period is specific for applied mechanisms and substances.

In an aspect, the chemical interaction of the deposition process may include a chemical reaction between a first substance and a second substance. As an example, the first substance and the second substance may be two different substances that transform through a chemical reaction into a third substance that forms the coating layer on the target surface. The reaction may be enabled only as long as the first substance is in an enabling form, for example, in a liquid form, and the first substance may remain in the liquid form only while it is in a saturated vapor of the first chamber, and begin to solidify when taken out of the first chamber and exposed to the ambient atmosphere. In such case, the limited interaction period is initiated when the object is removed from the first chamber, i.e. in the end of exposure of the surface of the object to the aerosol in the first chamber. Alternatively, the first substance may remain in the enabling form on the target surface only for some time after deposition on a surface and in the end of the limited interaction period transform into a disabling form. For example, the enabling form of the first substance may be liquid and a film formed on the target surface may turn into a disabling solid form some time after its deposition on the target surface. In such case, the limited interaction period is initiated when the object is loaded into the first chamber, i.e. in the beginning of exposure of the surface of the object to the aerosol in the first chamber, and ends after a defined period, notwithstanding whether it is exposed to the ambient atmosphere between the chambers or not.

In an aspect, the chemical interaction of the deposition process may include a catalytic interaction between a first substance and a second substance. The first substance may be a catalyst to a chemical reaction of the second substance, or the second substance may be a catalyst to a chemical reaction of the first substance. A catalyst may be applied, for example, to expedite the deposition process of the bulk substance, for example, coagulation of the particles, or change characteristics of the bulk substance, for example, development of color shades etc. The catalyst property may similarly last for the limited interaction period after loading of the object to or from the first chamber.

In an aspect, the chemical interaction of the deposition process may include an interaction in which a first substance and a second substance mix or adhere, when a deposited layer of the first substance is exposed to the second substance. The mixing may be enabled only as long as the first substance is in an enabling state, for example, in a liquid form, and the first substance may remain in the liquid form only while it is in a saturated vapor of the first chamber. In such case, the limited interaction period is initiated when the object is removed from the first chamber, i.e. in the end of exposure of the surface of the object to the aerosol in the first chamber. For example, particles of the first substance may be droplets of an adhesive liquid, and particles of the second substance may be solid particles that may mix with or adhere to the first substance as long as the first substance is in a liquid form.

In an aspect, the deposition process may include a chemical interaction in which an expendable first substance prepares the target surface for deposition by a second substance. For example, the substance of the first aerosol may include liquid droplets of a solvent or some other substance with high wetting ability, and the second aerosol may include droplets of a second substance that forms the bulk of resulting coating. It has been detected that in the beginning of deposition, the micrometer-sized droplets that settle on a solid surface tend to accumulate into millimeter-sized beads, which easily results in unevenness of the resulting coating layer. Such may happen especially if the layer to be coated is very thin such that the early unevenness does not have time to be leveled out with the increasing coating. The formation of the initial beads may be prevented or at least decreased by depositing on the coated surface first a layer of the first substance, which is a liquid that has stronger wetting ability than the second substance. The limited interaction period in this case is initiated in the end of exposure of the target surface to the aerosol in the first chamber, and terminates by evaporation of the first substance from the target surface. The first substance with high wetting ability spreads evenly on the coated surface, and droplets of the second substance settle evenly on the liquid layer of the first substance, without accumulating first into the larger beads. Accordingly, with the described mix of substances, the bulk liquid can be deposited in a non-impact state on the coated surface, and a uniform layer is consistently formed, even if the coated layer of the bulk liquid is very thin.

In any of the described aspects, aerosol in at least one of the chambers is in a non-impact state. However, aerosols in both the first chamber and the second chamber may be advantageously arranged into the non-impact state. When particles of both substances settle evenly onto the coated surface, the chemical or mechanical effect pursued with the multi-component process takes place in an easily controlled and unified manner throughout the target surface.

As an example, the aerosol in the first chamber 101 may be in a non-impact state and include droplets of a liquid coloring mixture, the aerosol in the second deposition chamber 103 may be in a non-impact state and include droplets of a catalyst mixture applicable to, for example, develop the color to a desired shade, to expedite drying of the color mixture or to strengthen the final layer composition of the color mixture.

As a further example, the aerosol in the first deposition chamber 101 may be in a non-impact state and include droplets of a liquid coloring mixture, aerosol in the second deposition chamber 103 may be in a non-impact state and include droplets of a resin mix applicable to create a transparent protective layer on the color layer.

As a further example, the aerosol in the first deposition chamber 101 may be in a non-impact state and include droplets of a first liquid substance, and the aerosol in the second deposition chamber 103 may be in a non-impact state and include solid pigment particles. In the first deposition chamber, the first liquid substance spreads evenly on the target surface of the object, and provides an adhesive layer on it. In the second deposition chamber, the pigment particles also spread evenly on the target surface, and adhere to the adhesive layer, creating an evenly colored coating on all surfaces of the object.

As a further example, the aerosol in the first deposition chamber 101 may include droplets of a first liquid substance, and the aerosol in the second deposition chamber 103 may include droplets of a second liquid substance, wherein the ability of the first liquid substance to maintain contact with a solid surface of the object (wetting) is greater than of the second liquid substance. At least the aerosol of the second chamber is advantageously in the non-impact state. When the second liquid substance is less prone to wet, the deposited droplets of the second liquid substance tend to move horizontally on the surface of the object, and accumulate thereon first into larger beads. This increases the possibility of variations in thickness of the resulting coating. In the proposed arrangement, the first liquid substance in the first deposition chamber adheres easily to the surface of the object, and creates a pre-treated wet surface, onto which the settled second liquid substance easily adheres on the spot. The first liquid substance will evaporate from the coating, and a more even coating by the second liquid substance is thus achieved.

The coating apparatus includes also a loading element 108, which may be configured to load the surface of the object into the second chamber before termination of the limited interaction period. The loading element may be configured to load the target surface to the first chamber and the second chamber, for example, through an inlet in a top surface of the chamber, or through an inlet in one or more side surfaces of the chamber. When the chemical interaction includes a chemical reaction between a first substance and a second substance, a coating layer of a third substance is formed, which third substance is a reaction product from the reaction between the first substance and the second substance. When the chemical interaction includes a catalyst relation between a first substance and a second substance, a coating layer of the bulk substance is formed. When the chemical interaction includes mixing or adherence between a first substance and a second substance, a coating layer of a mix of the first substance and the second substance is formed. When the chemical interaction includes use of an expendable first substance to prepare the target surface for deposition by the second substance, a coating layer of the bulk substance is formed.

The target surface may remain loaded in the first chamber until a layer of the first substance is created, and the thickness of the layer of the first substance depends on how long the exposure to the first aerosol is. At exposure to the second aerosol, depending on properties of the first substance and the second substance, the chemical interaction may penetrate to the layer of the first substance instantly or gradually. For example, if the first substance is a liquid and the second substance includes solid particles, the rate at which mixing of the particles penetrates to the layer of the first substance depends on the viscosity of the liquid and the size of the particles.

FIG. 2 illustrates possible results of the use of the limited interaction period in an exemplary case where the limited interaction period begins when the target surface is removed from the first chamber. In FIG. 2, P0 denotes a point of time when the limited interaction period is initiated by the target surface being removed from the first chamber. P1 denotes a point of time when the target surface is loaded into the second chamber. P3 denotes a point of time when the target surface is removed from the second chamber.

In some applications, the limited interaction period becomes extended by the exposure to the second aerosol in the second chamber. For example, if the first substance is a liquid that solidifies in the ambient atmosphere, but not in the second aerosol of the second chamber, the limited interaction period is extended by the duration of exposure to the second aerosol in the second chamber. P2a denotes here a point of time of the end of a non-extended limited interaction period, meaning in a case where the interaction period is not extended by the exposure to the second aerosol in the second chamber. P2b denotes a point of time of the end of an extended limited interaction period. The limited interaction period thus elapses either between P1 and P2a or between P0 and P2b, depending on the application.

In case of the extended limited interaction period P0-P2b, the target surface may be removed from the second chamber at P3 when the limited interaction period is ongoing. Structures 210 and 212 illustrate possible compositions of the resulting coating layer in such case. Depending on the speed of progress of the chemical interaction in the layer thickness direction, the resulting coating at P3 may include a uniform layer structure 210 of the first substance and the second substance, or of a third substance resulting from the chemical reaction between the first substance and the second substance. Alternatively, the resulting coating at P3 may include a partial layer structure 212 with a first layer 214 of the first substance and a second layer 216 of the first substance and the second substance, or a second layer 216 of a third substance resulting from the chemical reaction between the first substance and the second substance.

In case of the non-extended limited interaction period P0-P2a, the target surface may be loaded from the second chamber when the limited interaction period is expired. Structures 218 and 220 illustrate possible compositions of the resulting coating layer in such case. After the limited interaction period, the chemical interaction no longer takes place, and the second substance deposits on top of the coating layer. The resulting coating 218 may include a first layer 222 of both the first substance and of the second substance, and a second layer 224 of the second substance. Alternatively, the resulting coating 220 may include a first layer 226 of the first substance, a second layer 228 of the second substance, and an intermediate layer 230 of both the first substance and the second substance. Alternatively, the intermediate layer 230 may be of a third substance resulting from the chemical reaction between the first substance and the second substance.

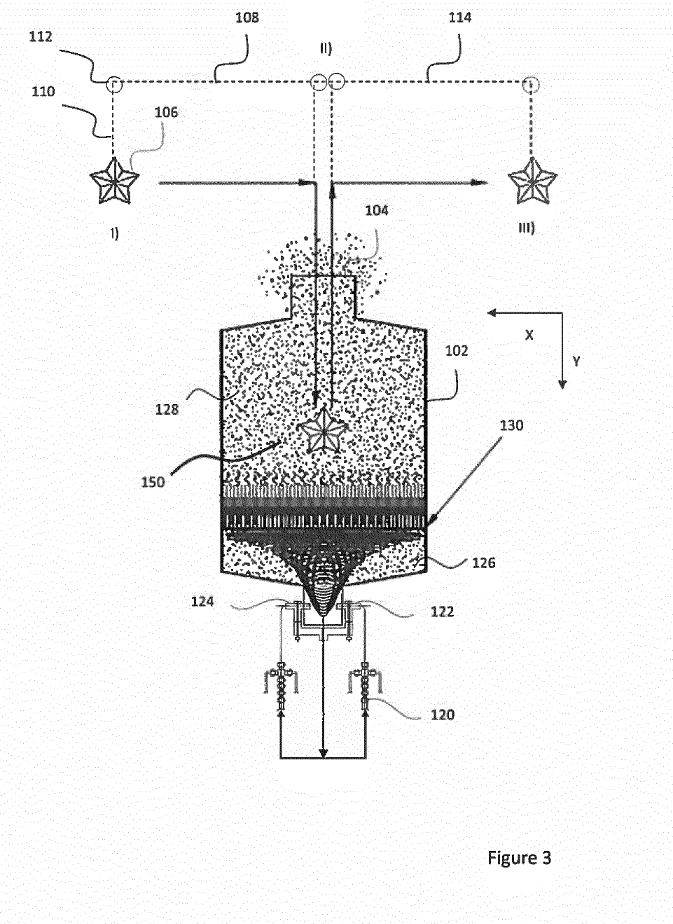

FIG. 3 illustrates a coating device including an exemplary deposition chamber applicable in the coating process. The coating device includes a deposition chamber 102, applicable as a first chamber 101 and/or the second chamber 103 of FIG. 1. A chamber refers here to a solid structure that forms an enclosed space with a non-zero volume. The term enclosed means here that the solid structure of the deposition chamber enables formation of a volume cell that has no interference or only gradual interference from the outside. The conditions within the deposition chamber are therefore mainly determined by the initial state of the volume in the deposition chamber, physical and chemical events that take place in the deposition chamber, and controlled input operations to and output operations from the deposition chamber. The deposition chamber may include an opening 104 that enables loading and unloading of objects for deposition within the chamber. The opening may be permanently open, or include a closure mechanism that enables opening and closing of the opening 104, in each case, however, arranged to enable minimal unintentional exchange of the aerosol volume in the deposition chamber with the ambient atmosphere.

The coating device includes also a loading element 108 configured to load an object 106 into the deposition chamber 102, and unload the object 106 from the deposition chamber 102. In FIG. 3, the loading structure 108 has been illustrated with a wire transfer system that includes a vertical wire connector 110 that can be removably attached to the object and a rolling mechanism 112 allows the wire of the vertical wire connector 110 to be lengthened or shortened, thereby enabling lowering and lifting of the object in a vertical direction. The rolling mechanism 112 may also include a slide, for example a rotary slide, which enables transfer of the vertical wire connector along a horizontal wire connector 114. The wire transfer system shown in FIG. 2 is, however, exemplary only. Any loading mechanism applicable for transferring objects to be coated into the deposition chamber may be used within the scope. For example, as will be described with later embodiments, the deposition chamber 102 may include a side wall with one or more openings (e.g. a hatch, or a door or the like) that allow loading of the object into the deposition chamber and from the deposition chamber in the horizontal direction.

The coating device 100 includes also a source of aerosol configured to feed into a bottom part of the deposition chamber a flow of aerosol that includes solid or liquid particles in gas. In the exemplary embodiment of FIG. 3, the aerosol source is illustrated by means of an atomization element 120 with inlets inside the deposition chamber 102. The deposition chamber can be considered to enclose a bottom part 126 and a top part 128, wherein the bottom part is below the top part. If denoted that the vertical direction Y corresponds to the direction of the gravitation, the bottom part 128 of the deposition chamber is a part of the deposition chamber lowest (closest to the ground) in the vertical direction, when the deposition chamber is in use. The top part is then opposite to the bottom part in the vertical direction, when the deposition chamber is in use. The feed of the atomization element 120 is arranged to a position in the bottom part of the deposition chamber. The atomizer is adapted to generate an aerosol with very small particles, which disperse into the volume cell. Larger particles with a small terminal settling velocity tend to settle back towards the bottom part of the deposition chamber and can be collected and re-fed as liquid to the atomization element 120. However, smaller particles with a very long terminal settling velocity act more or less like gas molecules of the aerosol gas, disperse into the volume cell and collide with other particles and the gas molecules.

The term aerosol refers here to a colloidal system of solid or liquid particles in a suspending gas. The liquid or solid particles have diameter mostly smaller than 1 μm or so. In the deposition chamber, particles of the aerosol undergo gravitational settling and tend to reach a terminal settling velocity. Accordingly, when the aerosol source is in the top part of the deposition chamber, or in the absence of the aerosol source, particles within the deposition chamber tend to settle linearly downwards in the direction of the gravitation. When the aerosol source is in the bottom part of the deposition chamber, it creates there a volumetric flow that disperses radially to the enclosed chamber volume and rises in the deposition chamber against the direction of the gravitational settling of the particles. For example, let us assume that the diameter of the cylindrical chamber of FIG. 3 is 38 cm, i.e the cross-sectional area of the chamber is A=11.34 dm². If the rate of aerosol input is V=30 dm³/min, the volumetric flow rises approximately v=V/A=4.4 mm/s.

It has now been detected that by means of an application-specific adjustment of the aerosol input in the bottom part of the deposition chamber, the terminal settling velocity of particles in the top part of the chamber can be controllably slowed down such that instead of linearly undergoing gravitational settling, particles practically float in the suspending gas, or settle with extremely slow velocity downwards. In these conditions, particles are mainly subject to complex interparticle interactions of particle agglomeration, due to which the direction of their motion is mainly random. The particles in the top part thus move practically evenly in all directions. Accordingly, when an object is enclosed into the top part of the deposition chamber, particles approach it from all directions, not only linearly from above. The random motion of particles floating in the aerosol also enables penetration of the particles to cavities and pores of the object, notwithstanding their orientation to the gravitation. An even coating is thus deposited on all exposed surfaces of the object.

Accordingly, the aerosol source is adjusted to generate a volumetric flow that rises in the deposition chamber against the direction of gravitational settling of the particles. Creation of the volumetric flow is adjusted to minimize the terminal settling velocity of the particles in the top part to a positive value below a predefined limit. An aerosol where values of the terminal settling velocity of the particles is below the predefined limit is herein called a floating aerosol. In the floating aerosol, random mode of motion of the particles prevails over gravitational settling mode of the particles. It has been detected that this unexpected deposition mode is achieved when the terminal settling velocity of the particles is controlled to a range below 1 mm/s.

The particles of floating aerosol in the top part of the deposition chamber can be considered to behave much like molecules of the aerosol gas. This means that due to collisions between the particles and gas molecules in the aerosol, the motion of the particles is random, and the direction from which the particles approach an object to be coated is similarly random. Because of this, particles distribute quite evenly over all surfaces of the object, notwithstanding whether a surface is horizontal or not. As the aerosol is denser than air it also supersedes air in open cavities or dents in the surface of the object to be coated, which further intensifies transportation of the particles towards non-linear surfaces of the object, or even into surfaces of a porous object. Advantageously, in use, the top part of the deposition chamber is filled with an amount of floating aerosol, and a constant concentration of the particles is maintained such that a stationary non-stop coating cell that includes a high concentration of particles with high mechanical mobility in all directions is formed. In case of liquid particles, the conditions in the deposition chamber are advantageously arranged to maintain a saturated state of vapor-liquid equilibrium where the rate of evaporation equals to the rate of condensation on a molecular level such that the net overall conversion from vapor to liquid and from liquid to vapor is practically zero. Existence of such stationary non-stop coating cell of floating aerosol may typically be determined visually, as the floating aerosol forms a fog-like cloud of substance that, after having filled the top part of the deposition chamber, due to the minimized terminal settling velocity, remains practically unchanged in it.

In FIG. 3, the aerosol source is illustrated by means of an atomizing apparatus that provides an aerosol including liquid droplets in gas. Similar arrangement is disclosed, for example, in an earlier patent application publication WO2015033027A1 of the Applicant. The apparatus includes two atomizers, wherein a first atomizer 122 is used for producing a first atomized aerosol jet and a second atomizer 124 is used for producing a second atomized aerosol jet. The atomized aerosol jets may be produced from one or more liquid precursors and discharged from the atomizer through a discharge opening in the atomizer. Each atomizer may comprise an atomizing head in which liquid is atomized into an atomized aerosol jet. Said atomizers may further comprise a focusing part arranged to restrain the atomized aerosol jet for providing a punctual aerosol jet, said focusing part extending directly from the atomizing head. The first atomizer 122 and the second atomizer 124 may be arranged to form an atomizer pair in which the focusing parts of the paired atomizers are directed towards each other. As a result, the first aerosol jet and the second aerosol jet collide to each other and form micro and nano scale droplets with a relatively narrow standard deviation of size. The collision of the aerosol jets produce a pressure point from which a planar aerosol zone will spread out creating an aerosol flow. The density of the droplets equalizes in the stationary deposition chamber and creates a rising volumetric flow, described earlier.

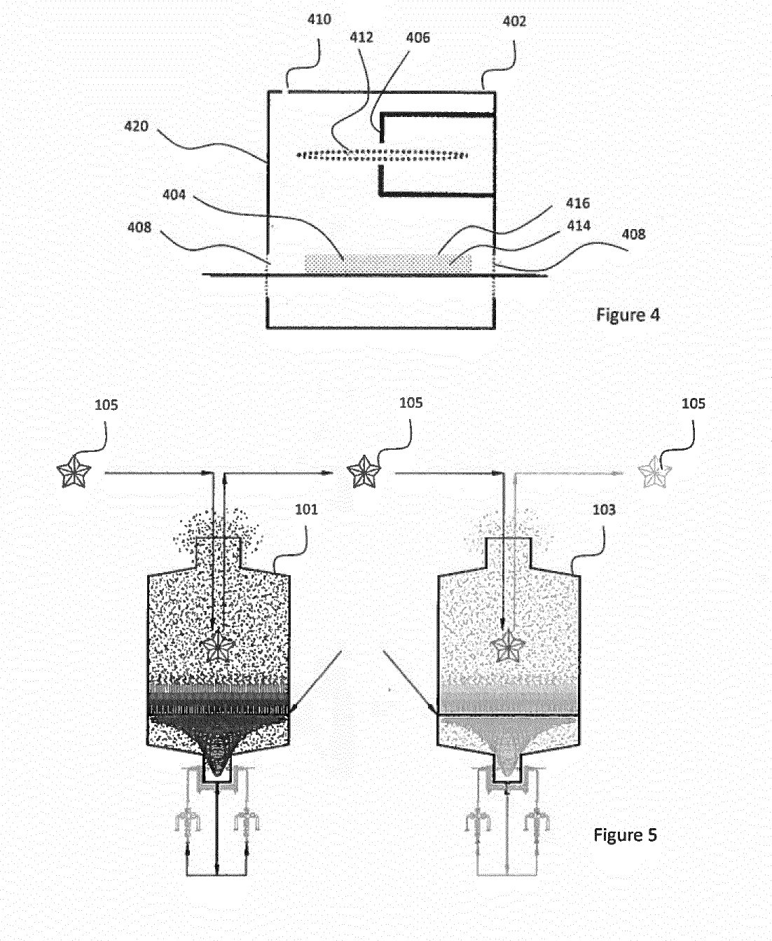

As discussed earlier, also gravitational settling may be applied. FIG. 4 illustrates an exemplary embodiment of a coating device 400 applicable to create an aerosol in a non-impact state where the liquid droplets are adjusted to settle onto the target surface by gravitational settling. Such aerosol is herein called as falling aerosol. The coating device 400 includes a deposition chamber 402, applicable as a first chamber 101 and/or the second chamber 103 of FIG. 1. In the example of FIG. 4, the falling aerosol created by the atomizer is a saturated aerosol with droplets that settle by gravitation on the object. The volume of the saturated aerosol is created by an atomization element located inside a top part of the deposition chamber, and the aerosol in non-impact state is formed below the atomization element in the volume of the saturated aerosol. FIG. 4 shows an exemplary deposition chamber 402 that includes a planar object 404 to be coated, positioned in the bottom part of the deposition chamber 402. A pair of atomizers 406 is arranged into the upper part of the deposition chamber 402. In this exemplary embodiment, the deposition chamber 402 defines a closed volume with openings 408 in the side walls 420 for the object 404 to enter and exit the deposition chamber 402, and an opening 410 for excess aerosol to exit in the top wall of the deposition chamber 402. Also in this example, at least one liquid substance may be atomized in two atomizing heads that are arranged into the deposition chamber, and positioned such that the heads are facing toward each other in a vertical direction. The aerosol jets collide each other in a collision point in a midpoint from the opposing atomizing heads. The collision creates a planar aerosol plane 412 which spreads radially and symmetrically in the deposition chamber 402. In this embodiment, the atomizers are arranged horizontally into the middle of the deposition chamber so that the saturated aerosol spreads uniformly in the chamber. However, the atomizers can also be placed in another position within the deposition chamber 402.

When the deposition chamber 402 is filled with saturated aerosol, the atomizers 406 continuously atomize liquid precursor into liquid droplets such that planar aerosol planes 412 are produced. Each aerosol plane 412 spreads horizontally in the deposition chamber 402 and unites with earlier aerosol planes so that a volume of falling aerosol in the non-impact state is formed, first to the lower part of the deposition chamber and then to the whole deposition chamber. In the non-impact region, the saturated aerosol falls slowly down by gravitation towards the bottom part of the deposition chamber 402 into which an object 414 with the target surface 416 is loaded. The droplets of the saturated aerosol are thus gravitationally settled on, and form a thin and even coating film on the target surface of the object.

FIG. 5 illustrates an exemplary embodiment of a coating device that includes two successive deposition chambers 101, 103, each applying floating aerosol deposition. This configuration is applicable in any of the aspects and exemplary processes described with FIG. 1.

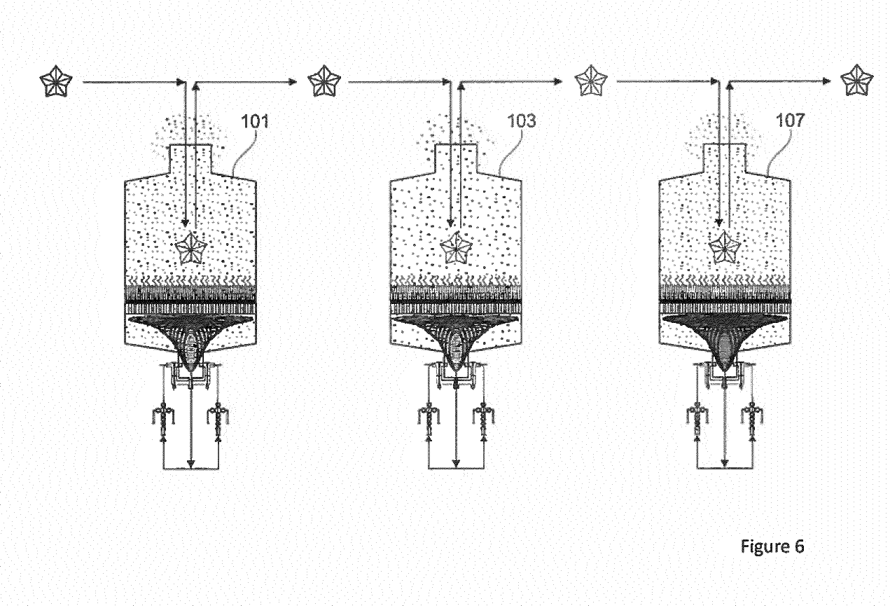

FIG. 6 illustrates a further exemplary embodiment of a coating device that includes three successive deposition chambers 101, 103, 107, each applying floating aerosol deposition. In the embodiment of FIG. 6, the first floating aerosol of the first deposition chamber 101 may include, for example, droplets of a liquid coloring mixture, the second floating aerosol of the second deposition chamber 103 may include droplets of a catalyst mixture applicable to develop the color to a desired shade, and the third floating aerosol of the third deposition chamber 107 may include droplets of a resin mix applicable to create a transparent protective layer on the color layer.

As another example, the first floating aerosol of the first deposition chamber 101 may include droplets of a first liquid substance, the second floating aerosol of the second deposition chamber 103 may include droplets of a second liquid substance that is reactive with the first liquid substance. In the first deposition chamber, the first liquid substance spreads evenly on the surfaces of the object, but does not solidify to create a durable coating. In the second deposition chamber, the second liquid substance also spreads evenly on the surfaces of the object, and the substances react creating a solid coating on all surfaces of the object. The third floating aerosol of the third deposition chamber 107 may again be used to create a transparent protective layer on the layer resulting from the reactions of the first and the second liquid substance.

As a further example, the first floating aerosol of the first deposition chamber 101 may include droplets of a first liquid substance, and the second floating aerosol of the second deposition chamber 103 may include solid pigment particles. In the first deposition chamber, the first liquid substance spreads evenly on the surfaces of the object, and provides an adhesive layer on them. In the second deposition chamber, the pigment particles also spread evenly on the surfaces of the object, and adhere to the first layer, creating an evenly colored coating on all surfaces of the object. The third floating aerosol of the third deposition chamber 107 may again be used to create a transparent protective layer on the layer resulting from the reactions of the first and the second liquid substance. Alternatively, the third floating aerosol of the third deposition chamber 107 may include solid pigment particles of another color such that the final color on the surfaces of the object results from pigment particles of the second deposition chamber 103 and the third deposition chamber 107.

On the other hand, the deposition chambers of FIG. 5 or 6 could be replaced by succession of deposition chambers configured to apply falling aerosol, as shown in FIG. 4. Furthermore, the coating apparatus may include a combination of deposition chambers, one or more applying floating aerosol, and one or more applying falling aerosol. Furthermore, the deposition chambers do not need to be applied in one-directional order of succession. An algorithm controlling the order of loading actions and/or the duration of loading actions may be applied to achieve a desired composition of the resulting coating film.

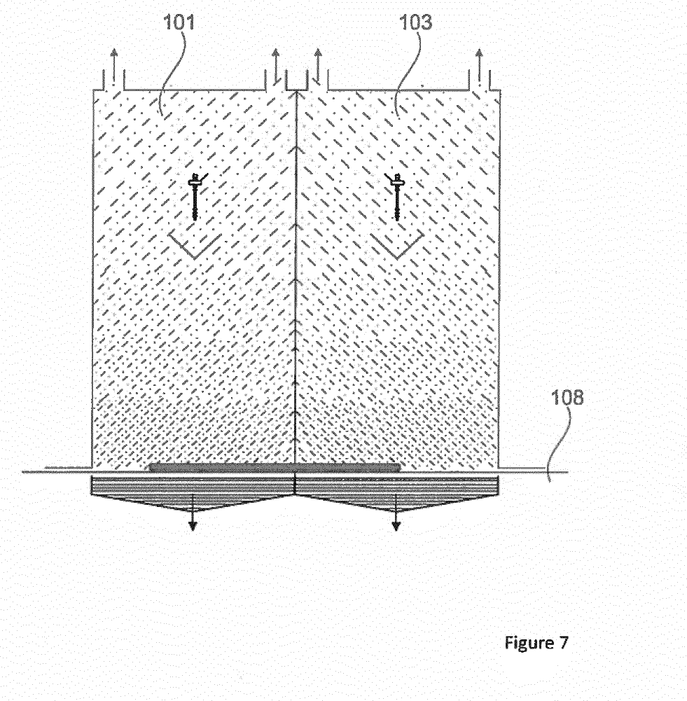

In the earlier exemplary embodiments, the first chamber and the second chamber are separated by a distance so that the target subject becomes exposed to an ambient atmosphere between the chambers. As shown in FIG. 7, it is also possible to couple the first chamber 101 to the second chamber 103 such that the loading element 108 can transfer the target surface directly from the first chamber 101 to the second chamber 103 such that the target surface does not become exposed to the ambient atmosphere between the exposure to the aerosol in the first chamber 101 and to the aerosol in the second chamber 103.

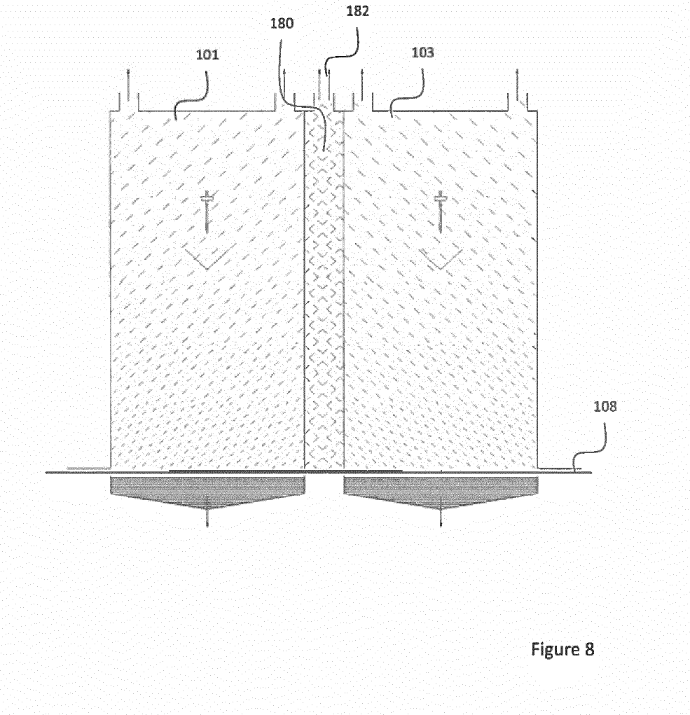

In directly connected configurations, illustrated in FIG. 7, openings required by the loading element 108 to transfer the target surface from the first chamber 101 to the second chamber 103 may enable mixing of the aerosol of the first chamber with the aerosol of the second chamber. This is not always acceptable, especially when the substances are mutually reactive. FIG. 8 illustrates a further exemplary configuration where a first intermediate chamber 180 is arranged between the first chamber 101 and the second chamber 103. The first intermediate chamber 180 may be arranged to have an outlet 182 for residual aerosol. The outlet may be configured with suction means for removing the aerosol from the intermediate chamber. The evident mixing of the aerosols may thus be arranged to take place in the intermediate chamber 180, thus minimizing mixing of the aerosols in the chambers.

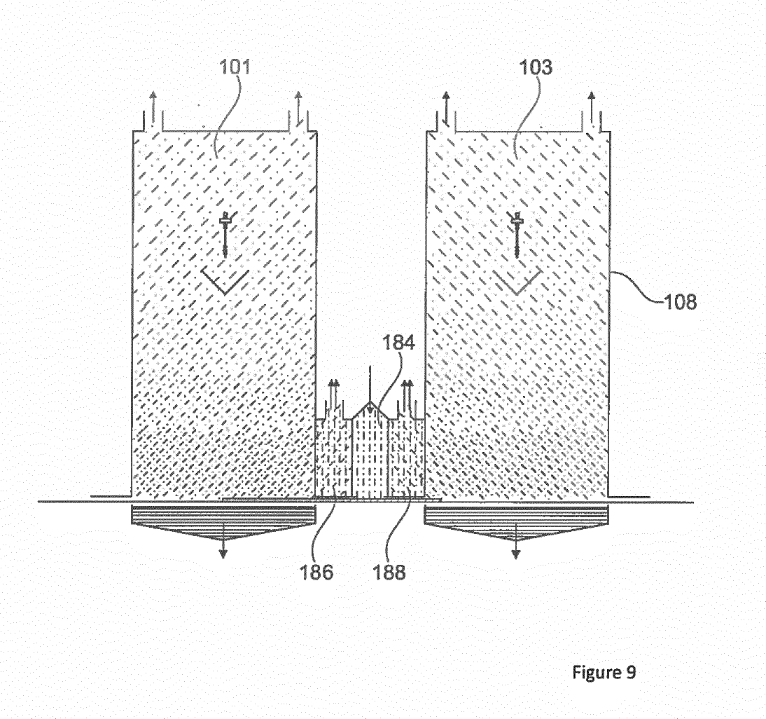

The residual aerosol removed from the intermediate chamber 180 of FIG. 8 includes a mix of the first aerosol and the second aerosol. FIG. 9 illustrates a further directly connected configuration that includes the first chamber 101, the second chamber 103 and a first intermediate chamber 184 between them. The first intermediate chamber 184 may be filled with inert gas or aerosol. The configuration may include also a second intermediate chamber 186 between the first chamber 101 and the first intermediate chamber 180. The second intermediate chamber 186 may be arranged to have an outlet with suction means for removal of residual aerosols. The aerosol in the first chamber 101 and the inert gas or aerosol in the first intermediate chamber 180 may mix in the second intermediate chamber 186 but no chemical reaction takes place. The configuration may include also a third intermediate chamber 188 between the second chamber 103 and the first intermediate chamber 180. The third intermediate chamber 188 may also be arranged to have an outlet with suction for residual aerosols. The aerosol in the second chamber 103 and the inert gas or aerosol in the first intermediate chamber 180 may mix in the third intermediate chamber 188 but again no chemical reaction takes place. In the configuration of FIG. 9, direct transfer without exposure to the ambient from the first chamber 101 to the second chamber 103 is enabled. Unintended mixing of the first aerosol and the second aerosol is prevented and residuals of both of the aerosols can be recovered.

The disclosed stationary deposition cells with floating or falling aerosol can be implemented in various ways to create thin, even layers by means of two or more component substances on planar or non-planar objects. Since the arrangement is very simple and robust, also larger scale objects, for example in the order of vehicle or machinery components may be coated with very thin films.

It is apparent to a person skilled in the art that as technology advances, the basic idea of the invention can be implemented in various ways. The invention and its embodiments are therefore not restricted to the above examples, but they may vary within the scope of the claims.

1. A method of coating a surface of an object, comprising:
depositing a coating in a process that includes chemical interaction between a first substance and a second substance;
creating into a first chamber an aerosol that includes particles of the first substance;
creating into a second chamber an aerosol that includes particles of the second substance;
determining a limited interaction period during which the chemical interaction between the first substance and the second substance is enabled, the limited interaction period being initiated in the beginning or end of exposure of the surface of the object to the aerosol in the first chamber;
adjusting the aerosol in the first chamber or in the second chamber to a non-impact state in which particles of the aerosol settle onto surfaces exposed to the aerosol;
loading the surface of the object into the first chamber; and
loading the surface of the object into the second chamber before termination of the limited interaction period.

2. The coating method of claim 1, characterized by the method including
creating the aerosol in the first chamber or in the second chamber by an atomization element located in a top part of the first chamber or the second chamber, particles of aerosol being liquid droplets of the first substance or the second substance, respectively;
adjusting the liquid droplets to settle onto the surface by gravitational settling.

3. The coating method of claim 1, characterized by the method including
creating the aerosol in the first chamber and in the second chamber by an atomization element located in a top part of the first chamber and in a top part of the second chamber, particles of aerosol in the first chamber being liquid droplets of the first substance, and particles of aerosol in the second chamber being liquid droplets of the second substance;
adjusting the liquid droplets in the first chamber and the liquid droplets in the second chamber to settle onto the surface by gravitational settling.

4. The coating method of claim 1, characterized by the first chamber or the second chamber enclosing a bottom part and a top part, wherein the bottom part is below the top part, and the method further including;
feeding into the bottom part an aerosol that includes solid or liquid particles in gas, thereby generating into the bottom part a volumetric flow that rises in the chamber against gravitational settling of the particles;
adjusting the rate of the volumetric flow to minimize the terminal settling velocity of the particles in the top part of the chamber such that a floating aerosol is created into the top part of the chamber.

5. The coating method of claim 1, characterized by the first chamber enclosing a first bottom part and a first top part, and the second chamber enclosing a second bottom part and a second top part wherein the first bottom part is below the first top part, the second bottom part is below the second top part, and the method further includes;
feeding into the first bottom part an aerosol that includes solid or liquid particles of the first substance in gas, thereby generating into the first bottom part a first volumetric flow that rises in the chamber against gravitational settling of the particles;
feeding into the second bottom part an aerosol that includes solid or liquid particles of the second substance in gas, thereby generating into the second bottom part a volumetric flow that rises in the chamber against gravitational settling of the particles;
adjusting the rate of the first volumetric flow to minimize the terminal settling velocity of the particles in the top part of the first chamber such that a first floating aerosol is created into the first top part of the first chamber;
adjusting the rate of the second volumetric flow to minimize the terminal settling velocity of the particles in the top part of the second chamber such that a second floating aerosol is created into the second top part of the second chamber.

6. The coating method of claim 4, characterized in that in the floating aerosol, random mode of motion of the particles prevails over gravitational settling mode of the particles.

7. The coating method of claim 5, characterized in that in the first floating aerosol and in the second floating aerosol, random mode of motion of the particles prevails over gravitational settling mode of the particles.

8. The coating method of claim 1, characterized by using as the first substance and the second substance two different substances that transform through a chemical reaction into a third substance.

9. The coating method of claim 1, characterized by using as the first substance a catalyst to a chemical reaction of the second substance, or using as the second substance a catalyst to a chemical reaction of the first substance.

10. The coating method of claim 1, characterized by using as the first substance with a significantly higher wetting ability that the wetting ability of the second substance.

11. The coating method of claim 1, characterized by further
keeping the surface of the object loaded in the first chamber until the layer of the first substance with the predefined thickness is created;
removing the surface of the object from the second chamber after the termination of the limited interaction period, whereby a layer of the second substance is deposited as a topmost sublayer.

12. The coating method of claim 1, characterized by further
keeping the surface of the object loaded in the first chamber until the layer of the first substance with the predefined thickness is created;
removing the surface of the object from the second chamber before the termination of the limited interaction period.

13. The coating method of claim 11, characterized in that the first substance is a liquid substance that solidifies by drying, and the method includes:
keeping the surface of the object loaded in the first chamber until the layer of the first substance with the predefined thickness is created;
loading the surface of the object into the second chamber before the limited interaction period terminates by solidifying of a topmost layer of the first substance.

14. The coating method of claim 1, characterized by adjusting the aerosol both in the first chamber and in the second chamber to a non-impact state in which particles of the second substance settle onto surfaces.

15. A coating apparatus for a process that that includes chemical interaction between a first substance and a second substance, the apparatus including:
a first chamber;
a second chamber;
a first aerosol source for feeding into the first chamber an aerosol that includes particles of the first substance;
a second aerosol source for feeding into the second chamber an aerosol that includes particles of the second substance;
wherein the first aerosol source or the second aerosol source is configured to adjust the aerosol to a non-impact state in which particles of the aerosol settle onto surfaces exposed to the aerosol; and
a loading element configured to load at least one surface of an object into the first chamber, and before termination of a limited interaction period into the second chamber, wherein the chemical interaction is enabled only during the limited interaction period, which is initiated in the beginning or end of exposure of the surface of the object to the aerosol in the first chamber.

16. The coating apparatus of claim 15, including an atomization element that is located in a top part of the first chamber and configured to create the aerosol with liquid droplets of the first substance, or is located in a top part of the second chamber and configured to create the aerosol with liquid droplets of the second substance; characterized in that the atomization element is configured to adjust the liquid droplets to settle onto the surface by gravitational settling.

17. The coating apparatus of claim 15, including a first atomization element located in a top part of the first chamber and configured to create the aerosol with liquid droplets of the first substance, and a second atomization element located in a top part of the second chamber and configured to create the aerosol with liquid droplets of the second substance; characterized in that the first atomization element and the second atomization element are both configured to adjust the liquid droplets to settle onto the surface by gravitational settling.

18. The coating apparatus of claim 15, characterized in that
at least one chamber of the first chamber or the second chamber encloses a bottom part and a top part, wherein the bottom part is below the top part;
the aerosol source of the chamber is configured to feed into the bottom part the aerosol that includes solid or liquid particles in gas, and thereby generate into the bottom part a volumetric flow that rises in the chamber against gravitational settling of the particles;
the aerosol source of the chamber is configured to adjust the rate of the volumetric flow to minimize the terminal settling velocity of the particles in the top part of the chamber such that a floating aerosol is created into the top part of the chamber.

19. The coating apparatus of claim 15, characterized in that
the first chamber encloses a first bottom part and a first top part, wherein the first bottom part is below the first top part;
the second chamber encloses a second bottom part and a second top part, wherein the second bottom part is below the second top part;
the aerosol source of the first chamber is configured to feed into the first bottom part an aerosol that includes solid or liquid particles of the first substance in gas, thereby generating into the first bottom part a first volumetric flow that rises in the chamber against gravitational settling of the particles;
the aerosol source of the second chamber is configured to feed into the second bottom part an aerosol that includes solid or liquid particles of the second substance in gas, thereby generating into the second bottom part a volumetric flow that rises in the chamber against gravitational settling of the particles;
the aerosol source of the first chamber is configured to adjust the rate of the first volumetric flow to minimize the terminal settling velocity of the particles in the top part of the first chamber such that a first floating aerosol is created into the first top part of the first chamber;
the aerosol source of the second chamber is configured to adjust the rate of the second volumetric flow to minimize the terminal settling velocity of the particles in the top part of the second chamber such that a second floating aerosol is created into the second top part of the second chamber.

20. The coating apparatus of claim 18, characterized in that in the floating aerosol, random mode of motion of the particles prevails over gravitational settling mode of the particles.

21. The coating method of claim 19, characterized in that in the first floating aerosol and in the second floating aerosol, random mode of motion of the particles prevails over gravitational settling mode of the particles.

22. The coating apparatus of claim 15, characterized in that
the loading element is configured to keep the surface of the object loaded in the first chamber until a layer of the first substance with a predefined thickness is created;
the loading element is configured to remove the surface of the object from the second chamber after the termination of the limited interaction period, whereby a layer of the second substance is deposited as a topmost sublayer.

23. The coating apparatus of claim 15, characterized in that
the loading element is configured to keep the surface of the object loaded in the first chamber until a layer of the first substance with a predefined thickness is created;
the loading element is configured to the loading element is configured to remove the surface of the object from the second chamber before the termination of the limited interaction period.

24. The coating apparatus of claim 15, characterized in that the first chamber and the second chamber are directly coupled such that no exposure to the ambient atmosphere takes place between exit from the first chamber and entry to the second chamber.

25. The coating apparatus of claim 24, characterized by at least one intermediate chamber with suction means between the first chamber and the second chamber.

26. The coating apparatus of claim 25, characterized by including
a first intermediate chamber;
a second intermediate chamber with suction means, the second intermediate chamber being between the first chamber and the first intermediate chamber;
a third intermediate chamber with suction means, the third intermediate chamber being between the second chamber and the first intermediate chamber;

27. A coated object, at least one surface of the object having a coating deposited by the method of claim 1.

28. The coated object of claim 27, characterized in that the coating includes a first layer of the first substance, a second layer of the second substance, and an intermediate layer of both the first substance and the second substance.

29. The object of claim 27, characterized in that the coating includes a first layer of the first substance, a second layer of the second substance, and an intermediate layer of a third substance between the first layer and the second layer, the third substance resulting from the chemical reaction between the first substance and the third substance.
